(19) United States
(12) Patent Application Publication
(10) Pub. No.: US 2007/0077959 A1
(43) Pub. Date: Apr. 5, 2007

(54) Electronic locator

(76) Inventors: Edward G. Newman, Fairfax, VA (US); Sean Newman, Fairfax, VA (US); Benjamin P. Newman, Fairfax, VA (US); Richard Bizar, Centreville, VA (US); Hsiao Liu, Lorton, VA (US)

Correspondence Address: JAMES J. RALARBATE, 5792 MAIN STREET, WILLIAMSVILLE, NY, 14221, US

(21) Appl. No.: 11/229,876

(22) Filed: Sep. 19, 2005

(51) Int. Cl. H04M 1/00

(52) U.S. Cl. 455/550.1

(57) ABSTRACT

This provides a system to emit a plurality of electronic signals, sent by a person(s) trapped by some disaster, such as collapse of building, earthquake, flood, etc. The plurality of signals provides a better chance that rescuers will receive at least one signal.

This invention relates to a locator device and, more specifically, to an electronic transmitter device that is enabled to be used in an emergency to locate individuals requiring emergency assistance, and/or in non-emergencies to control local and remote environments.

### BACKGROUND

When people are trapped as a result of fire, coal mine collapse, terrorist attack or natural disaster, it is important that they have some means to alert rescue teams of their location. If means were available to stranded or trapped people, their rescue could be greatly facilitated if the rescuers were aware of their location. Recent assaults on the USA and natural disasters have demonstrated a critical need for individuals to be able to communicate with and/or provide their location to others including emergency rescue staff, police, firemen and others, under extremely stressful conditions, both environmentally and psychologically. There are currently no practical methodologies, means or devices which permit this “automatic” location of individuals, nor that facilitate their ability to communicate their location and/or condition to others. The inability to communicate either by speech, digital text or preprogrammed messages, including location data, or other digital data, in the immediate area (up to 500 yards, or more) is further compounded when the individual is beneath the ground, in interior spaces with concrete and/or metal walls, or under rubble or trapped in submersibles and/or mines.

### SUMMARY

The present embodiments provide an information appliance or an electronic locator device that can communicate the location of its user to others by emitting several means of communication sequentially and/or communicate other information with other individuals or devices or structures. Often rescue teams have only one or two receivers such as a cell phone or push-to-talk communicators to receive messages; if the person trapped has no cell phone, it is impossible to direct the rescuers to the trapped location. The present invention provides a transmitter or electronic locator that emits at least two, but preferably a plurality of, signals that increase the chances at least one will handshake or be received by the rescue team or other desired targets of communication. By “several” is meant two or more signals.

Signals that are emitted sequentially by the electronic locator device include but are not limited to: AM radio, FM radio, XM radio, cellular mobile computers, GSM phones, microwave, sonar, satellite line-of-site, IEEE 802.11× communications standards and Infrared. Police, firemen or other rescuers are more likely to have one of these signal receivers which increases the probability of the trapped person being rescued.

While it is desirable for the locator device to have the ability to also receive communications, the embodiments may involve a simple signal transmitting item. As noted earlier, known communication means are used to provide the signal sent by the person or persons trapped or otherwise in need of assistance. Obviously, if electricity is still available, hard-wired phones may be used if the device is a “furnishing”; however, this is very unlikely in any type of real disaster. Known communication means such as cellular telephones, radio frequency, infrared, laser, fiber optics or other suitable communication may be used to provide the signal or signals. Any suitable communications means that will provide signals, usually sequentially, but intermittently is also feasible, will be used in the present embodiments. Communication could take the form of voice, data, codes, images, light and other sounds. Many appropriate known communication means include those disclosed in U.S. Pat. No. 5,844,824.

There are known sources of energy such as those normally available at home including electricity, battery, fuel cell, oil, natural gas, etc. Also known are deferred action batteries that are activated when they contact water, other liquids or other means such as vibration, change in barometric pressure, and impact. Many such deferred action batteries are used in emergency kits by pilots who may be shot down or sailors who for one reason or another are stranded at sea. These deferred action batteries would be appropriate for use in the present invention.

If the walls or structure of a residence or work place, or attachments or enclosures therein and thereto, have the ability to transmit signals, when they collapse, they may still have this ability. This structural component can be also found in hotels, airports, hospitals, schools, transportation means, vehicles and prisons. This embodiment includes the integration of computing and communications and electronics with typical furnishings or appurtenances to provide an intelligent environment for the area surrounding these furnishings.

In an embodiment, an electronic locator device is provided which comprises a structure which continuously emits, sequentially or intermittently, one or more distinct communication signals. These signals provide information to others that indicates their own or a person's location; this device being a user-“available” or supported item and/or a furnishing of many types housing or attached to a transmitter, and having a plurality of activation means including manual or automatic activation. By “available” means as a component of their home, vehicle, office or other structures. This item is selected from the group consisting of a campus, a residence, an office, a wristwatch, pendants, cameras, personal mobile computers, cell phones, PDA's/EDA's, clothing, glasses and jewelry. The electronic device can be enabled to both send and optionally to receive communications. Energy supplied for said locator device is a member selected from and/or a combination from the group consisting of but not limited to: solar energy, body movement, motion energy generation, water activation, heat exchange, fuel cells and batteries. The electronic device may have a preprogrammed message that is enabled to facilitate sender location information including the name of person seeking assistance and/or the location and/or ID address of the furnishing or embodiment in connection with the user itself. The device may also contain medical and other personal information for the person. The electronic device is enabled to provide voice transmission from the sender if needed and/or applicable. The device is enabled to continuously emit a plurality of signals until it runs out of power, or receives an acknowledgement or handshake from a receiver, or is manually or automatically turned off. This embodiment includes forms for a standard commercial/consumer environment, and/or forms for a rugged environment; the electronic locator device comprising in an operative arrangement a transmitter enabled to emit a plurality of sequential signals, with manual or automatic device activation. It is enabled to convey a spontaneous or preprogrammed signal. The transmitter is adapted to communicate information to others that indicates the location of the sender or, in the case of a furnishing encompassing a transmitter, that of the person the furnishing containing the transmitter is in connection with, by any communications means. The device is provided as a component in a member selected from the group consisting of a campus environment, a residence, a work place, a user supported item, vehicles, clothing, PDA's/EDA's and a mobile communication item. The communication signals as above noted are selected from the group consisting of AM radio, FM radio, RFs, cellular phones, XM radio, satellite line of site, microwave, sonar, Bluetooth, IEEE 802.11× communications means and infrared; said locator device may be intrinsically safe and/or ruggedized or MILSPEC. This ruggedized and/or MILSPEC device has a water-resistant or waterproof housing and is shock resistant or shock-proof. It is important that this device has a housing resistant to a member selected from the group consisting of dirt, dust, oil, gas, chemicals, heat, cold, pressure changes and impact.

As above stated, the source of the distinct communication signals can be a user-available or supported item generally electronic, or a furnishing/appliance encompassing or having attached a transmitter. Some are worn or user supported while others are located in a user available location such as the integration of computing and communications electronics in campuses, residences or offices, furnishings, ceiling furnishings, floor furnishings and wall furnishings.

The furnishings encompassing such transmitters can be formed into a local area network and/or a wide area network; either by fixed location of such furnishings or by the formation of an ad hoc network, with an optional automatic hand-shaking, to determine each other's existence as part of the network. These furnishings have their own address information, location information and can be in communications contact with a user-supported emergency location transmitter on or in a person in proximity to the LAN and/or WAN. This LAN/WAN interacting with the person who has authority to control or interact with it, can in addition to serving as an emergency location service also offer many control services for that person in managing the environment housing it and the surrounding environs. Such control functions include but are not limited to: control of the area's security protection, lighting, entertainment devices, HVAC, meal preparation, laundry and house cleaning, and computing and communications services and means.

If a structure such as a campus, residence, office or work place, or entertainment/recreation, medical or law enforcement facility should collapse during a disaster, chances are that the structure could still provide usable communication means or at least partial availability of these computer and communication means. In this disclosure and claims, the term “furnishings” shall include all of the below items of paragraphs 011-019.

“Intelligent Furnishings”—(Means throughout this disclosure and claims the items of paragraphs 011 and 012.) Here one would use in the embodiment as communication means the integration of computing and communications and/or electronics with typical furnishings and/or appurtenances to provide an intelligent environment for the area surrounding the intelligent furnishings. This intelligent environment will therefore provide computation and communications capabilities as well as data and information exchange capabilities in the general area surrounding such furnishings. Such communications and computing capabilities may also be utilized to provide an intelligent environment for a room or space around such furnishings

The areas that will encompass such an intelligent environment include but are not restricted to campuses, homes, offices, hotels, airports, military installations, hospitals, schools, trains, airplanes, ships, buses, recreational vehicles and prisons. The means of communication may be wired or wireless, line of sight, spread spectrum, microwave, RF, IR or other suitable means. The integration of communication can also be accomplished by having communication components built into textiles or plastics to create such furnishings. Obviously, these furnishings can automatically handshake with one another.

“Intelligent Ceiling Furnishings”—(Means throughout this disclosure and claims the items of paragraph 013 and 014). In this embodiment, one would use the integration of computing and communications and/or electronics with typical ceiling furnishings and/or appurtenances to provide an intelligent environment for the area surrounding the intelligent ceiling furnishings. This intelligent environment will therefore provide computation and communications capabilities as well as data and information exchange capabilities in the general area surrounding such furnishings. Typical ceiling furnishings will include but are not limited to light fixtures, cameras, fire and smoke detectors, murals, skylights, speakers and ventilation fixtures and vents.

The areas that will encompass such an intelligent environment include but are not restricted to campuses of all kinds, homes, offices, hotels, airports, military installations, hospitals, schools, trains, airplanes, ships, buses, recreational vehicles and prisons. The means of communication may be wired or wireless, line of sight, spread spectrum, RF, IR, microwave or any other means.

“Intelligent Textiles and Materials” (Means throughout this disclosure and claims the items of paragraph 015). This embodiment will also include the integration of such computing and communications components into conductive textiles and/or plastics to create such furnishings (intelligent and conductive textiles and materials).

“Intelligent Floor Furnishings”—(Means throughout this disclosure and claims the items of paragraph 016 and 017). In this embodiment, the available communication means would involve the integration of computing and communications and/or electronics with typical floor coverings and furnishings and/or appurtenances to provide an intelligent environment for the area surrounding the intelligent wall furnishings. This intelligent environment will therefore provide computation and communications capabilities as well as data and information exchange capabilities in the general area surrounding such furnishings. Typical floor furnishings will include but are not limited to carpeting, tiles, vinyl coverings, light fixtures, cameras, stair wells, “trim”, mats and rugs, drinking fountains, pools, fire and smoke detectors, murals, speakers and ventilation fixtures and vents.

The areas that will encompass such an intelligent environment include but are not restricted to campuses, homes, offices, hotels, airports, military installations, hospitals, schools, trains, airplanes, ships, buses, recreational vehicles and prisons. The means of communication may be wired or wireless, line of sight, spread spectrum, RF, IR, microwave or any other means. This embodiment also includes the integration of such computing and communications components into conductive textiles and/or plastics to create such furnishings (intelligent and conductive textiles and materials).

“Intelligent Wall Furnishings”—(Means throughout this disclosure and claims the items of paragraphs 018 and 019). In this embodiment, the available communication means would provide the integration of computing and communications and/or electronics with typical wall furnishings and/or appurtenances to provide an intelligent environment for the area surrounding the intelligent wall furnishings. This intelligent environment will therefore provide computation and communications capabilities as well as data and information exchange capabilities in the general area surrounding such furnishings. Typical wall furnishings will include but are not limited to paintings, wallpaper, wall “trim”, window and door frames, mirrors, light fixtures, camera, fire and smoke detectors, murals, ornaments, speakers, fans/air conditioning systems and ventilation fixtures and vents.

The areas that will encompass such an intelligent environment include but are not restricted to homes, offices, hotels, airports, military installations, hospitals, schools, trains, airplanes, ships, buses, recreational vehicles and prisons. The means of communication may be wired or wireless, line of sight, spread spectrum, RF, IR, microwave or any other means.

It will be appreciated that various of the above-disclosed and other features and functions, alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electronic device which comprises a structure which continuously and/or intermittently emits sequentially several distinct communication signals that provide information to others that indicates a sender's and/or a furnishing's location and/or other personal information; said device being either a user-available or supported item and/or a “furnishing” embodying such a capability, and having a plurality of activation means including manual or automatic activation.

2. The electronic locator device of claim 1 wherein said item is selected from the group consisting of a campus, a residence, an office, a vehicle, a wristwatch, pendants, cameras, personal mobile computers, cell phones, PDA's/EDA's, clothing, medical implants, glasses and jewelry.

3. The electronic locator device of claim 1 wherein said device is enabled to both send and receive communications, and said device is enabled to manually or automatically be turned on or off.

4. The electronic locator of claim 1 wherein said communication signals are those emitted from a member selected from the group consisting of AM and FM radio, RF, microwave, cellular phones, XM radio, satellite line of site, sonar, Bluetooth, laser fiber optics, IEEE 802.11 communications standards means, Infrared means and others.

5. The electronic locator of claim 1 where energy supplied for said locator device is a member selected from the group consisting of electricity, solar energy, body movement, motion energy generation, water activation, heat exchange, fuel cells and batteries.

6. The electronic device of claim 1 having a preprogrammed message or signal that is enabled to facilitate sender location information including the name and location of the person seeking assistance, or the location and address of the furnishing hosting such a capability in communication with the person.

7. The electronic device of claim 1 enabled to provide voice transmission of the sender and/or to receive analog or digital voice commands.

8. The electronic device of claim 1 whereby the device is enabled to continuously emit signals until it loses power or receives an acknowledgement or handshake from a receiver, or one which intermittently checks for/emits signals.

9. An electronic locator device comprising in an operative arrangement a transmitter from an electronics location enabled to emit/receive a plurality of sequential signals, having manual or automatic device activation and enabled to convey a spontaneous or preprogrammed signal from/to said electronics location, said transmitter adapted to communicate information to others that indicates a location and/or other desired information, said device being provided as a component in a member selected from the group consisting of a campus, a residence, a school, a hospital, a work place, a vehicle, a user supported item, vehicles, clothing, PDA's/EDA's and a mobile communication item, said communication signals selected from the group consisting of AM radio, FM radio, RF, microwave, cellular phones, XM radio, satellite line of site, sonar, Bluetooth, laser, fiber optics, IEEE 802.11× and Infrared communications devices, said locator device optionally being intrinsically safe.

10. The locator device of claim 9 wherein said device is enabled to both send and receive signals and communication and said device is enabled to manually or automatically be turned on or off.

11. The locator device of claim 9 where energy supplied for said locator device is a member selected from the group consisting of electricity, motion energy, solar energy, water activation, heat exchange, fuel cells and batteries.

12. The device of claim 9 having a waterproof and shock resistant housing.

13. The device of claim 9 having a housing resistance to a member selected from the group consisting of dirt, dust, oil, gas, chemical, heat, cold, pressure change and/or impact.

14. The device of claim 9 wherein electronics for emitting said location communication signals are located in structures in a member selected from the group consisting of intelligent furnishings, intelligent ceiling furnishings, intelligent floor furnishings and intelligent wall furnishings.

15. A system capable of emitting several distinct electronic signals comprising an electronics source location selected from the group consisting of intelligent furnishings, intelligent ceiling furnishings, intelligent floor furnishings, intelligent wall furnishings, and mixtures thereof.

16. The device of claim 15 wherein said electronics location is provided in intelligent furnishings.

17. The device of claim 15 wherein said electronics location is provided in intelligent ceiling furnishings.

18. The device of claim 15 wherein said electronics location is provided in intelligent floor furnishings.

19. The device of claim 15 wherein said electronics location is provided in intelligent wall furnishings.

20. The device of claim 15 wherein a local area network (LAN) and/or wide area network (WAN) is created by the interaction of furnishings of all kinds, such as LAN/WAN, which is addition to providing emergency contact information and a communications means for a person in need of assistance, also provides an intelligent environment that allows a person to control and/or adjust that environment and its furnishings, appliances and/or mechanical systems.
